(19) United States
(12) Patent Application Publication
(10) Pub. No.: US 2016/0074816 A1
(43) Pub. Date: Mar. 17, 2016

(54) ANTIBIOFOULING MEMBRANES AND METHODS FOR PRODUCTION

(71) Applicant: FLINDERS UNIVERSITY OF SOUTH AUSTRALIA, Bedford Park (AU)

(72) Inventors: Milena GINIC-MARKOVIC, Paradise (AU); Stephen Ross CLARKE, Morphett Vale (AU); Kristina Teresa CONSTANTOPOULOS, Malvern (AU); Elda MARKOVIC, Morphettville (AU)

(73) Assignee: FLINDES UNIVERSITY OF SOUTH AUSTRALIA, Bedford Park (AU)

(21) Appl. No.: 14/785,019

(22) PCT Filed: Apr. 17, 2014
(86) PCT No.: PCT/AU2014/000444

§ 371 Date: Oct. 16, 2015

(30) Foreign Application Priority Data
Apr. 19, 2013 (AU) 2013901380

(51) Int. Cl. B01D 71/56; B01D 69/12; B01D 65/08; B01D 67/00; C09D 5/16; C09D 177/06

(52) U.S. Cl. CPC B01D 71/56; C09D 5/16; C09D 177/06; B01D 65/08; B01D 67/0006; B01D 69/125; B01D 2323/40

(57) ABSTRACT

Disclosed herein is a composite filtration membrane comprising a porous support membrane and an antibiofouling polyamide layer on the porous support membrane. Also disclosed herein is a method for manufacturing the composite filtration membrane and a cross-linked copolymer.

### PRIORITY DOCUMENT

The present application claims priority from Australian Provisional Patent Application No. 2013901380 titled “ANTIBIOFOULING MEMBRANES AND METHODS FOR PRODUCTION” and filed on 19 Apr. 2013, the contents of which are hereby incorporated by reference in their entirety.

### TECHNICAL FIELD

The present invention relates generally to selective filtration membranes, and more specifically to reverse osmosis membranes.

### BACKGROUND

Selective filtration membranes, such as reverse osmosis membranes, nanofiltration membranes, ultrafiltration membranes, and microfiltration membranes, are used in a wide range of applications to separate dissolved substances from their solvents. For example, reverse osmosis (“RO”) membranes are commonly used in the desalination of brackish water or seawater to provide relatively pure water suitable for industrial, agricultural or residential use.

(The common type of reverse osmosis membrane is a composite membrane comprising of a micro- to sub-microporous support and a thin polyamide (“PA”) film formed On the micro- to sub-microporous support. Typically, the polyamide film is formed by an interfacial polymerisation of a polyfunctional amine and a polyfunctional acyl halide. For example. U.S. Pat. No 4,277,344 describes the formation of a polyamide film using m-phenylenediamine and trimesoyl chloride.

However, composite polyamide reverse osmosis membranes tend to stiffer from biological fouling which results from an accumulation of biofouling organisms (pico-, micro- or macro-organisms, DNA or viruses or bacteria) and or associated biofilm forming materials on the surface of the membrane, thereby causing a reduction in flux exhibited by the membrane and requiring operating pressures to be varied frequently to compensate for the variations in flux. Consequently, membranes often need to be cleaned chemically to remove the biofouling and this can require the membrane to be taken off-line which affects that overall efficiency of a filtration apparatus.

There have been many suggestions or proposals for reducing biofouling of composite polyamide membranes. Many proposals involve coating the polyamide layer with a polymer or other material having hydrophilic groups. For example, in U.S. Pat. No. 6,177,011 it is suggested that fouling can be reduced by coating the polyamide film of the reverse osmosis membrane with an electrically neutral organic substance or a polymer that has a nonionic hydrophilic group. Another approach for dealing with fouling has been to incorporate polyalkylene oxide groups onto the polyamide surface of the membrane. For example, U.S. Pat. No. 6,280,853 describes a composite membrane comprising a porous support and a cross-linked polyamide surface having polyalkylene oxide groups grafted thereto. Unfortunately, polyalkylene oxide polymers are not stable and are easily oxidised in the presence of oxygen or transition metal ions, both of which are present in reverse osmosis filtrations.

We have previously produced a low-fouling composite polyamide filtration membrane in which a sulfobetaine polymer is covalently grafted from the polyamide layer (International patent application WO 2011/088505). Whilst the antibiofouling properties of this membrane were good, the production method was not particularly amenable to commercial scale production.

There is a need for processes and materials for producing low biofouling filtration membranes that overcome one or more of the problems associated with prior art processes and materials.

### SUMMARY

According to a first aspect, there is provided a composite filtration membrane comprising a porous support membrane and an antibiofouling polyamide layer on the porous support membrane, said antibiofouling polyamide layer comprising a copolymer formed by co-polymerisation of an aromatic diamine monomer, an amino zwitterionic monomer, and a cross-linking monomer comprising a plurality of amine-reactive functional groups.

According to a second aspect, there is provided a method for producing a composite filtration membrane, the method comprising:

depositing, on a porous support membrane, a mixture comprising an aromatic diamine monomer, an amino zwitterionic monomer and a cross-linking monomer comprising a plurality of amine-reactive functional groups: and

allowing the aromatic diamine monomer and amino zwitterionic monomer to react with the cross-linking monomer to form an antibiofouling cross-linked polymer layer on the porous support membrane.

In embodiments of the second aspect, the step of depositing the mixture comprising an aromatic diamine monomer, an amino zwitterionic monomer and a cross-linking monomer comprising a plurality of amine-reactive functional groups on the porous support membrane comprises depositing, on the porous support membrane, an aqueous mixture comprising the aromatic diamine monomer and the amino zwitterionic monomer to form an initial film layer and then contacting the initial film layer with a mixture comprising the cross-linking monomer and a solvent.

According to a third aspect, there is provided a cross-linked copolymer formed by co-polymerisation of an aromatic diamine monomer, an amino zwitterionic monomer and a cross-linking monomer comprising a plurality of amine-reactive functional groups.

In embodiments of the first, second and third aspects, the aromatic diamine monomer is m-phenylenediamine.

In embodiments of the first, second and third aspects, the amino zwitterionic monomer is selected from the group consisting of sulfobetaine, phosphobetaine, and carboxybetaine monomers.

In embodiments of the first, second and third aspects, the amino zwitterionic monomer is selected from the group consisting of mono-amino and di-amino monomers.

In embodiments of the first, second and third aspects, the amino zwitterionic monomer has a structure according to formula (I):

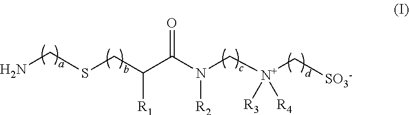

wherein: a, b, c, and d are integers each of which is independently selected from the group consisting of 1, 2, 3, 4, and 5; R₁ and R₂ are each independently selected from the group consisting of H and optionally substituted C₁-C₆ alkyl; and R₃ and R₄ are each independently selected from the group consisting of optionally substituted C₁-C₆ alkyl, optionally substituted C₃-C₆cycloalkyl, and optionally substituted aryl.

In embodiments, a is 2.

In embodiments, b is 1.

In embodiments, c is 3.

In embodiments, d is 3.

In embodiments, R₁ is selected from the group consisting of methyl, ethyl and n-propyl. In specific embodiments, R₁ is methyl.

In embodiments, R₂ is H.

In embodiments, R₃and R₄ are selected from the group consisting of methyl, ethyl and n-propyl. In specific embodiments, R₃ and R₄ are both methyl.

In specific embodiments, the amino zwitterionic monomer has a structure according to formula (II) (referred to herein as “amino-SBMA”):

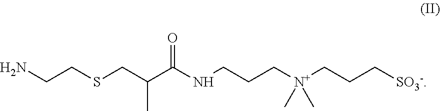

In embodiments of the first, second and third aspects, the cross-linking monomer comprising a plurality of amine-reactive functional groups is an aromatic monomer. In embodiments, the cross-linking monomer comprising a plurality of amine-reactive functional groups comprises three amine-reactive functional groups. In embodiments, the amine-reactive functional groups have the formula —C(O)X wherein X is a leaving group. In specific embodiments, the cross-linking monomer comprising a plurality of amine-reactive functional groups has a structure according to formula (III):

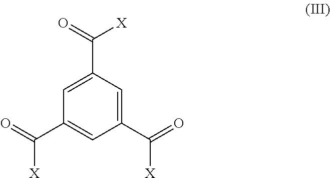

wherein X is a leaving group.

In embodiments, X is Cl.

In specific embodiments of the first, second and third aspects, the aromatic diamine monomer comprises to-phenylenediamine, the amino zwitterionic monomer comprises the compound of formula (III), and the cross-linking monomer comprising a plurality of amine-reactive functional groups comprises trimesoyl chloride.

In embodiments of the first and second aspects, the porous support membrane comprises a polysulfone membrane.

### BRIEF DESCRIPTION OF THE FIGURES

Embodiments of the present invention will be discussed with reference to the accompanying figures.

FIG. 1 shows a route for the synthesis of amino-sulfobetaine derivative 4.

FIG. 2 is a schematic diagram showing the stepwise synthetic protocol for the fabrication of polyamide (PA) amino-sulfobetaine mixed thin film composite reverse osmosis membrane.

FIG. 3 shows attenuated total reflectance Fourier transform infrared (ATR-FTIR) spectra of (a) commercial. UF-polysulfone (PSf) membrane, (b) thin-film composite (TFC) of PA coated polysulfone membrane, and (c) mixed thin-film composite of polyamide and amino-sulfobetaine (0.1 wt %) coated polysulfone membrane.

FIG. 4 shows confocal laser scanning microscope (CLSM) images of bacteria adhered on PA TFC membrane. Right and left images obtained from two different spots.

FIG. 5 shows CLSM images of bacteria adhered on mixed TFC membrane of PA and 0.05 wt % amino-sulfobetaine. Right and left images were obtained from the two different spots.

FIG. 6 shows CLSM images of bacteria adhered on mixed TFC membrane of PA and 0.1 wt % amino-sulfobetaine. Right and left images were obtained from the two different spots.

FIG. 7 shows CLSM images of bacteria adhered on mixed TFC membrane of PA and 0.2 wt % amino-sulfobetaine. Right and left images were obtained from the two different spots.

FIG. 8 shows plots showing the relative pure water flux (η) properties of control PA membranes (PAM) and 0.1 wt % amino-sulfobetaine modified PAM tested at a pressure of 2400 kPa (348 psi).

FIG. 9 shows a plot of flux (left y-axis) and rejection (right y-axis) for a commercially available membrane (left); a TFC membrane of PA and 0.2 wt % amino-sulfobetaine (centre); and a TFC membrane of PA and 0.4 wt % amino-sulfobetaine.

FIG. 10 shows plots of flux vs time for a TFC membrane of PA prepared according to Example 2 (♦) and a commercially available membrane (); and rejection vs time for a TFC membrane of PA prepared according to Example 2 (⋄) and a commercially available membrane (◯).

### DESCRIPTION OF EMBODIMENTS

We have developed a composite filtration membrane comprising a porous support membrane and an antibiofouling polyamide layer on the porous support membrane. The antibiofouling polyamide layer comprises a copolymer formed by the interfacial co-polymerisation of an aromatic diamine monomer, an amino zwitterionic monomer, and a cross-linking monomer comprising a plurality of amine-reactive functional groups.

As used herein, the terms “antibiofouling”, “non-biofouling” and related terms when used in relation to a layer or coating means that the layer is capable of reducing biological fouling of a surface relative to a surface that does not have the antibiofouling layer. Thus, antibiofouling does not necessarily mean that there is no accumulation of fouling organisms and/or associated biofilm forming materials on the surface of the membrane. Biological fouling (“biofouling”) results from an accumulation of fouling organisms (pico-, micro- or macro-organisms) and/or associated biofilm forming materials on a surface. The organisms and their secretions of extracellular polymeric substances (EPS) form a biofilm that is stabilised by weak physico-chemical interactions including electrostatic interactions, hydrogen-bonding and van der Waals interactions. Any of the tests provided herein or known by the skilled person can be used to determine whether or not there is a reduction in biological fouling. For example, direct measurement of microbial growth on the membrane surface can be used to determine whether or not there is a reduction in biological fouling.

The filtration membrane may be a reverse osmosis membrane. Reverse osmosis membranes typically have a top polyamide layer of about 200 nanometres thickness. A second or middle layer typically comprises an engineering plastic, such as polysulfone, and it typically has a thickness of about 30-60 microns. This second layer provides a smooth surface for the top layer, and it enables the top layer to withstand relatively high operating pressures. A third or bottom layer is typically nonwoven polyester, e.g., a polyethylene terephthalate (PET) web or fabric, with a thickness typically of about 120 microns.

Reverse osmosis membranes are usually employed in either flat panel or spiral wound configurations. The flat panel configuration is typically a plurality of membranes separated from one another by a porous spacer sheet, stacked upon one another and disposed as a panel between a feed solution and a permeate discharge. The spiral wound configuration is simply a membrane/spacer stack coiled about a central feed tube. Both configurations are known in the art.

Prior art polyamide layers have been formed by polymerisation of m-phenylenediamine and trimesoyl chloride on a surface of the membrane. However, the polyamide formed is susceptible to fouling. We have found that introducing an amino zwitterionic monomer into the polymerisation process produces a polyamide layer in which the co-polymerised amino zwitterionic monomer confers antibiofouling properties on the membrane.

Following the processes described herein, the polyamide layer is formed by condensation polymerisation of the aromatic diamine monomer, the amino zwitterionic monomer, and the cross-linking monomer. The interfacial polymerisation can be carried out in solution, suspension, emulsion or bulk. Advantageously, the polymerisation reaction can be carried out directly on the surface of the porous support membrane. Thus, the present invention provides a cross-linked copolymer formed by interfacial co-polymerisation of an aromatic diamine monomer, an amino zwitterionic monomer and a cross-linking monomer comprising a plurality of amine-reactive functional groups.

As used herein, the term “monomer” means any molecule that can be reacted with another to form a polymer and includes within its scope pre-polymers.

The “amino zwitterionic monomer” is a monomer comprising at least one zwitterionic group and at least one amino group. Zwitterionic monomers are electrically neutral (i.e., carry no total net charge) but they carry formal positive and negative charges on different atoms in the molecule.

The zwitterionic group may be a sulfobetaine, phosphobetaine, carboxybetaine or derivatives thereof. Sulfobetaines and derivatives thereof may be particularly suitable because they tend to exhibit strong biocompatibility and consequently may extend the range of applications for which the membranes may be used (for example, biomedicine). Whilst we have found sulfobetaines to be particularly suitable, it is possible that other zwitterionic groups such as phosphobetaine and carboxybetaine groups could also be used.

The amino zwitterionic monomer may be a mono-amino or a di-amino monomer.

The amino zwitterionic monomer may have a structure according to formula (I):

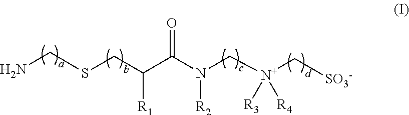

wherein: a, b, c, and d are integers each of which is independently selected from the group consisting of 1, 2, 3, 4, and 5; R₁ and R₂ are each independently selected from the group consisting of H and optionally substituted C₁-C₆ alkyl; and R₃ and R₄ are each independently selected from the group consisting of optionally substituted C₁-C₆ alkyl, optionally substituted C₃-C₆ cycloalkyl, and optionally substituted aryl.

In embodiments, a is 2.

In embodiments, b is 1.

In embodiments, c is 3.

In embodiments, d is 3.

In embodiments, R₁ is selected from the group consisting of methyl, ethyl and n-propyl. In specific embodiments, R₁ is methyl.

In embodiments, R₂ is H.

In embodiments, R₃ and R₄ are selected from the group consisting of methyl, ethyl and n-propyl. In specific embodiments, R₃ and R₄are both methyl. This provides a compound of formula (II) (also referred to herein as “amino-SBMA”):

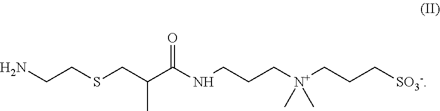

As discussed, we have previously prepared an antibiofouling membrane by grafting a sulfobetaine polymer from a polyamide surface of the membrane via surface initiated ATRP (International patent application WO 2011/088505). The methods described herein differ from the methods disclosed in WO 2011/088505 in that the zwitterionic monomer forms part of the polyamide layer by interfacial co-polymerisation with the aromatic diamine monomer and the cross-linking monomer comprising a plurality of amine-reactive functional groups.

The aromatic diamine monomer may be any monomer comprising at least one aromatic ring and two or more amine groups. Thus, the term ‘diamine’ includes within its scope two or more amine groups. In specific embodiments, the aromatic diamine monomer may be selected from one or more of the group consisting of o-phenylenediamine (OPD), m-phenylenediamine (MPD), p-phenylenediamine (PPD), 2,5-diaminotoluene, 4,4′-diaminobiphenyl, and 1,8-diaminonaphthalene. In specific embodiments, the aromatic diamine monomer is m-phonylenediamine.

In embodiments, the cross-linking monomer comprising a plurality of amine-reactive functional groups is an aromatic monomer. The cross-linking monomer may comprise three amine-reactive functional groups. The amine-reactive functional groups may have the formula —C(O)X wherein X is a leaving group. The leaving group may be selected from the group consisting of Cl, Br, and I, and OTs (“tosylate”).

In specific embodiments, the cross linking monomer comprising a plurality of amine-reactive functional groups has a structure according to formula (III):

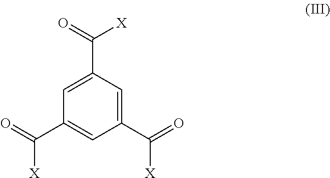

wherein X is a leaving group.

X may be selected from the group consisting of Cl, Br, and I, and OTs. In embodiments, X is Cl.

In specific embodiments, the aromatic diamine monomer comprises m-phenylenediamine, the amino zwitterionic monomer comprises amino-SBMA, and the cross-linking monomer comprising a plurality of amine-reactive functional groups comprises trimesoyl chloride.

The amino zwitterionic monomer may be present in an amount of from about 0.05 to about 0.2 wt % with respect to the aromatic diamine monomer,

The composite filtration membrane is prepared by depositing, on the porous support membrane, a mixture comprising the aromatic diamine monomer, the amino zwitterionic monomer and the cross-linking monomer comprising a plurality of amine-reactive functional groups. The aromatic diamine monomer and amino zwitterionic monomer are then allowed to react with the cross-linking monomer to form the antibiofouling cross-linked polymer layer on the porous support membrane.

The step of depositing the mixture comprising an aromatic diamine monomer, an amino zwitterionic monomer and a cross-linking monomer comprising a plurality of amine-reactive functional groups on the porous support membrane may be carried out in two stages: depositing, on the porous support membrane an aqueous mixture comprising the aromatic diamine monomer and the amino zwitterionic monomer to form an initial film layer; and then contacting the initial film layer with a mixture comprising the cross-linking monomer and a solvent.

The initial film layer can be prepared by coating a surface of the porous support membrane with an aqueous mixture comprising the aromatic diamine monomer and the amino zwitterionic monomer. Excess aqueous mixture can then be removed from the membrane by suitable means, such as physically removing the excess by draining it from the surface, or by blotting with paper or a sponge etc.

The aqueous mixture may contain the aromatic diamine monomer in an amount of from about 0.1 to about 10 wt %, such as 0.5 wt %, 1 wt %, 2 wt %, 3 wt %, 4 wt % or 5 wt %, in some embodiments, the aqueous mixture contains the aromatic diamine monomer in an amount of about 1 wt %.

The aqueous mixture may contain the amino zwitterionic monomer in an amount of up to about 10 wt %, such as from about 0.01 to about 10 wt % or from about 0.01 to about 5 wt %. Specifically, the aqueous mixture may contain the amino zwitterionic monomer in an amount of 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt % or 10 wt %. In some embodiments, the aqueous mixture contains the amino-SBMA in an amount of about 0.05 wt %. In some other embodiments, the aqueous mixture contains the amino-SBMA an amount of about 0.1 wt %. In some other embodiments, the aqueous mixture contains the amino-SBMA in an amount of about 0.2 wt %. In some other embodiments, the aqueous mixture contains the amino-SBMA in an amount of about 0.4 wt %.

Advantageously, the aqueous mixture also contains an acid. The acid may affect the oxidation levels of the aromatic diamine monomer and catalyse the polymerisation reaction. The acid may be an organic acid or an inorganic acid. Suitable acids include camphor-10-sulfonic acid (CSA), hydrochloric acid, phosphoric acid, sulfuric acid, dodecylbenzenesulfonic acid (DBSA), p-toluenesulfonic acid (pTSA), and succinic acid. The acid may be present in the aqueous mixture in an amount of from about 1 wt % to about 5 wt %. In embodiments, the acid is CSA. In some embodiments, the CSA is present in the aqueous mixture in an amount of about 2 wt %.

The aqueous mixture may also comprise a surfactant to assist in wetting the surface of the porous support membrane. The surfactant may be any surfactant known in the art. Suitable surfactants include sodium dodecyl sulphate (SDS), ammonium lauryl sulphate, sodium laureth sulphate, sodium myreth sulphate, dioctyl sodium sulfosuccinate, perfluorooctanesulfonate (PFOS), perfluorobutanesulfonate, and linear alkylbenzene sulfonates (LABs). In some embodiments, the surfactant is SDS. The surfactant may be present in the aqueous mixture in an amount of from about 0.1 wt % to about 1 wt %. In some embodiments, the surfactant is present in the aqueous mixture in an amount of 0.15 wt %.

The aqueous mixture may also comprise a co-solvent. Suitable co-solvents include water soluble solvents such as lower alkyl alcohols, acetone, tetrahydrofuran, and the like. Suitable lower alkyl alcohol co-solvents include methanol, ethanol, n-propanol, iso-propanol, n-butanol, iso-butanol, and tert-butanol. In some embodiments, the co-solvent is iso-propanol. The co-solvent may be present in the aqueous mixture in an amount of from about 0.5 wt % to about 5 wt %. In some embodiments, the co-solvent is present in the aqueous mixture in an amount of 1 wt %.

After formation of the initial film layer, the mixture comprising the cross-linking monomer comprising a plurality of amine-reactive functional groups and a solvent is applied. Suitable solvents for the cross-linking monomer include hydrocarbon solvents and aromatic solvents, such as hexane, benzene, xylenes, toluene, and the like. In some embodiments, the solvent is n-hexane. The cross-linking monomer may be present in the mixture in an amount of from about 0.01% w/v to about 0.2% w/v. In some embodiments, the cross-linking monomer is present in the mixture in an amount of 0.05% w/v. After contacting the initial film layer for a time of 30 seconds to 5 minutes, excess mixture comprising the cross-linking monomer is removed from the surface of the porous support membrane by physical means such as by draining it from the surface. The surface may be washed with a suitable solvent, such as hexane, to remove any residual reagents, and the membrane dried.

The polyamide layer formed using the processes described herein provides a substantially uniform coverage of zwitterionic groups over the surface of the membrane.

The resultant membranes can be characterised using any suitable methods, such as ATR-FTIR, thermogravimetric analysis (TGA), atomic force microscopy (AFM) and water contact angle (WCA) measurements.

The biofouling resistance of membranes can be measured using a number of methods, including measuring the flux and/or salt rejection. For example, the biofouling performance of the membranes can be assessed by the direct measurement of microbial growth on the membrane surface and the flux and/or salt rejection. This can be achieved using a stirred cell, or dead end filtration apparatus or a cross-flow apparatus.

A reverse osmosis membrane, in order to be commercially useful in desalinating brackish water or seawater on a large scale, must possess certain properties. Firstly, the membrane must have a high salt rejection coefficient. For many commercial applications, the reverse osmosis membrane should have a salt rejection capability of at least about 97%. Secondly, the membrane must have a high flux characteristic, i.e., the ability to pass a relatively large amount of water through the membrane at relatively low pressures. Typically, the flux for the membrane should be greater than 10 gallons/ft²-day (gfd) at a pressure of 800 psi for seawater and should be greater than 15 gfd at a pressure of 220 psi for brackish water. For certain applications, a rejection rate that is less than that which would otherwise be desirable may be acceptable in exchange for higher flux and vice versa.

The membranes formed using the processes described herein may be suitable for a range of RO applications, such as raw water pretreatment, tertiary wastewater treatment, and perchlorate or nitrate removal from drinking water or groundwater.

The present invention is hereinafter further described by way of the following non-limiting example(s) and accompanying figure(s).

### EXAMPLES

### Example 1

### Preparation of Amino-SBMA (4)

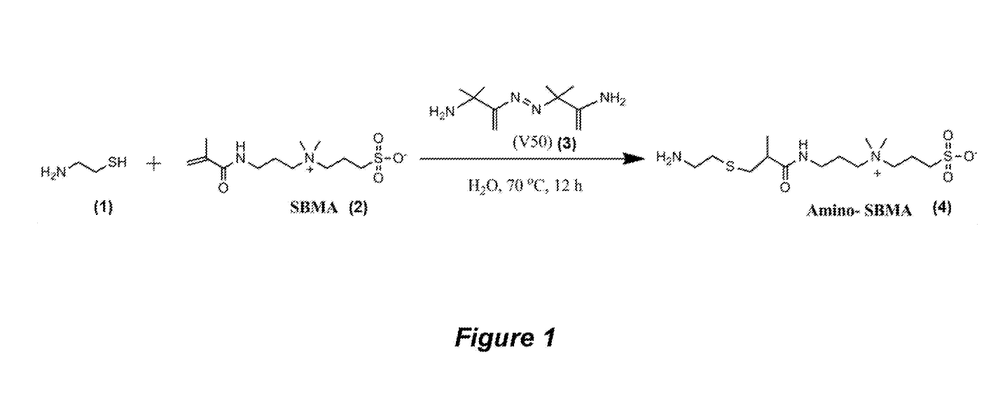

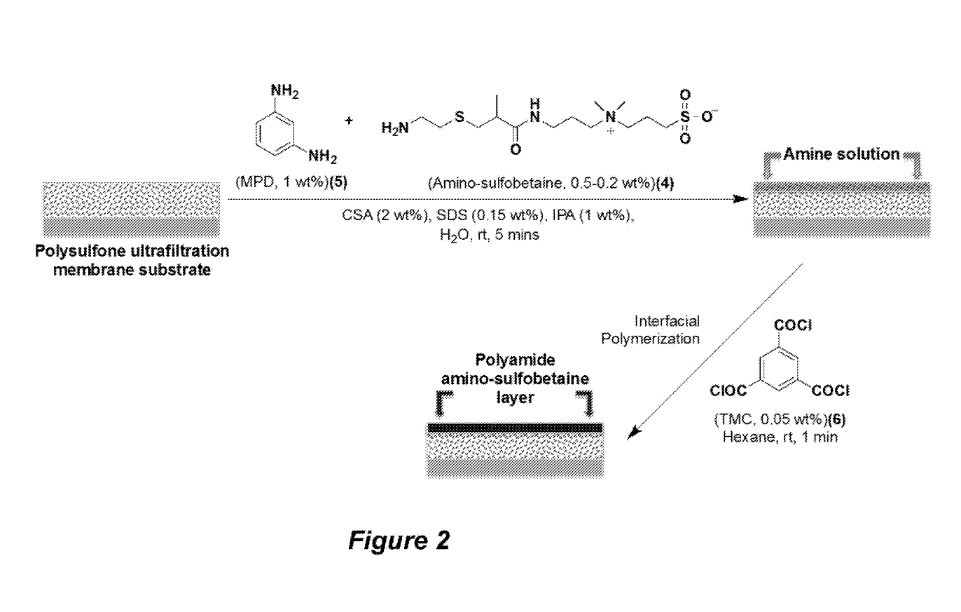

Referring to FIG. 1, a two-neck round bottom flask was charged with sulfobetaine methacrylate (SBMA) (2) (10 g, 34.2 mmoles) dissolved in deionised (DI) water (50 mL) and placed under N₂. After 30 minutes, 2-aminoethane-thiol (1) (2.64 g, 34.2 mmoles) was added and the temperature was increased to 70° C. Then 2,2′-azobis(2-methylpropionamidine) dihydrochloride (V50 catalyst, 100 mg) dissolved in DI water (5 mL) was added, and the reaction mixture was left stirring overnight at 70° C. The reaction mixture was concentrated on a rotavap and the resulting gummy syrup was triturated with diethylether (2×100 mL). The product amino-SBMA (4) was dried under N₂ or using a freeze drier and stored in brown colour sealed vial under dark. Yield 12.5 g (99%):, ¹H NMR (D₂O, 600 MHz) δ: 3.46-3.43 (m, 2H), 3.40-3.33 (m, 4H), 3.26-3.21 (m, 1H), 3.08 (s, 6H), 2.94 (t, 2H, J=7.2 Hz), 2.80 (t, J=6.6 Hz), 2.65 (d, 2H, J=7.2 Hz), 2.63-2.60 (m, 2H), 2.19-2.18 (m, 2H), 2.01-1.97 (m, 2H), 1.13 (d, 3H, J=6.6 Hz); Mass spec. calculated for C₁₄H₃₂N₃O₄S₂: 370, 1834 [M+H]⁺, observed: 370.1840.

### Example 2

### Preparation of Polyamide Amino-Solfobetaine Thin Film Composite (TFC) Membranes

An ultrafiltration (UF)-polysulfone (PSf) support membrane (purchased from GE) with a size of 30 cm×1.5 cm was immersed in deionized (DI) water overnight then isopropanol (IPA) for 10 min, then the membrane was washed with DI water (2×50 mL) and positioned on a PMMA (polymethylmethacrylate) plate. A Neoprene rubber gasket and a PMMA frame were placed on top of the support membrane, and binder clips were used to hold the plate-membrane-gasket-frame stack together. 100 mL of a m-phenylenediamine (MPD)/amino-SBMA solution (1 wt % MPD (i.e. 1 g of MPD in 100 mL DI water), 0.01 to 10 wt % amino-SBMA, 2 wt % of camphor-10-sulfonic acid (CSA), 0.15 wt % of sodium dodecyl sulphate (SDS) and 1 wt % of IPA) were poured into the frame and allowed to contact the PSf membrane for 5 min before draining the excess MPD)/amino-SBMA solution. The frame and gasket were disassembled, and residual solution between the plate and the PSf membrane was removed using paper towels. Residual droplets of solution on the top surface of the PSf membrane were removed by rolling a rubber roller followed by purging with nitrogen, gas flow across the membrane surface. Afterwards, the frame and gasket were reassembled on top of the PSf membrane, and 100 mL of 0.05% (w/v) trimesoyl chloride (TMC) in n-hexane were poured onto the frame. After 1 min, the TMC/n-hexane solution was drained from the frame, and the frame and gasket were disassembled. The membrane surface was rinsed using n-hexane (100 mL) to wash away residual reagents, and the membrane was dried in air at ambient conditions for 1 min. Finally, the entire membrane was immersed in DI water until further use.

### Example 3

### ATR-FTIR Characterisation of Polyamide Amino-Sulfobetaine Thin Film Composite (TFC) Membranes

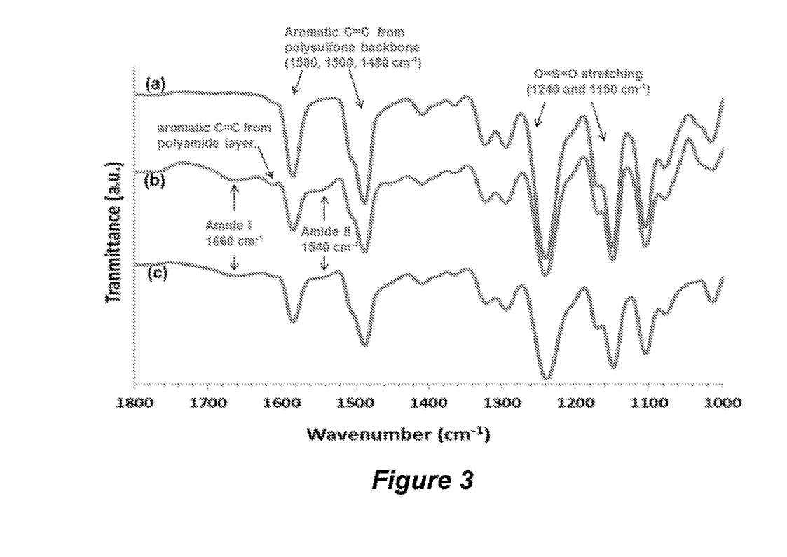

ATR-FTIR spectroscopy was used to characterise the chemical structure of the modified and unmodified RO membranes. ATR-FTIR spectra were obtained using a Thermo-Nicolet Nexus 870 FTIR spectrometer (Thermo Electron Corporation) fitted with the diamond attenuated total reflectance (ATR) attachment, and data was collected in air in the mid infrared region (4000-400 cm⁻¹). The resolution was 4 cm⁻¹ with 128 scans. The data analysis was manipulated using Omnic software. The data are shown in FIG. 3.

### Example 4

### Anti-Biofouling Studies (Bacterial Resistance Test) of Polyamide Amino-Sulfobetaine Thin Film Composite (TFC) Membranes

A nutrient solution was prepared in order to feed naturally occurring bacteria that exist in the environment. Sodium chloride (99%) (2 g, 0.034 mol), sodium acetate anhydrous (200 mg, 2.43×10⁻³ mol), sodium phosphate monobasic (20 mg, 166×10⁻⁴ mol), sodium nitrate (40 mg, 5.7×10⁻⁴ mol) were all dissolved in 1 L of Milli-Q water to make the following concentration: (carbon: 100 ppm), (nitrogen: 40 ppm) and (phosphate: 20 ppm) in saline water (2000 ppm NaCl). The modified and unmodified membranes were cut to (2 cm×2 cm) and placed into small vials. Nutrient solution was then added to the vials in enough volume as to cover the membrane. The vials were covered for 48 h at room temperature and left in the dark. Then the nutrient solution was removed, and the membranes were treated with a fixative solution as described below.

To prepare the fixative solution, paraformaldehyde (4.00 g) was dissolved in PBS buffer at pH=7.4 (60.0 mL) at 60° C. Sucrose (4.0 g, 11.7 mmol) was then added and the solution, was allowed to cool to room temperature. Glutaraldehyde solution (25% in water, 2.0 mL) was added and the final volume was adjusted to 100 mL using PBS. The exposed membranes were covered with the fixative solution for 24 h. After fixing, the membranes were rinsed in PBS buffer prior to dehydration by immersion for 15 min each in a series of ethanol/water solutions (ethanol concentrations were 50% v/v, 70% v/v, 85% v/v and 95% v/v and 100% of ethanol). The membranes were then dried overnight in a fume hood by placing them between filter paper.

The dried membranes were stained with 4′,6-diamidino-2-phenylindole (DAPI, 0.4 ppm) solution for 2 h at room temperature in the dark. After that, the membranes were rinsed with DI water and then dried at room temperature for 1 h. The bacteria on the membrane were imaged by using the Confocal Laser Scanning Microscopy (CLSM.).

The bacteria on the membrane were imaged by using the Leica TCS SP5 CLSM. The CLSM was equipped with argon, 405 nmn diode, DPSS 561 and HeNe 633 lasers, and also equipped with specific detectors and filters set for monitoring the fluorescence from various dyes (for e.g., DAPI, excitation=341 nm, emission=452 nm). Bacteria images were observed with a water immersion lens (60× object and numerical aperture 1.4) and a series of images were generated through XYZ acquisition mode with zoom factor of 1.5, line average of 8 and frame average of 4. Each membrane with adhered bacteria was scanned randomly at 4-6 positions. The gained images covered an area of 164 μM×164 μM at resolution of 512×512 pixels. The CLSM images were analysed by using image J software (version 1.46r: National Institute of Health, USA) and the bacteria on membrane were quantified by using the ITCN plugin in the Image J software.

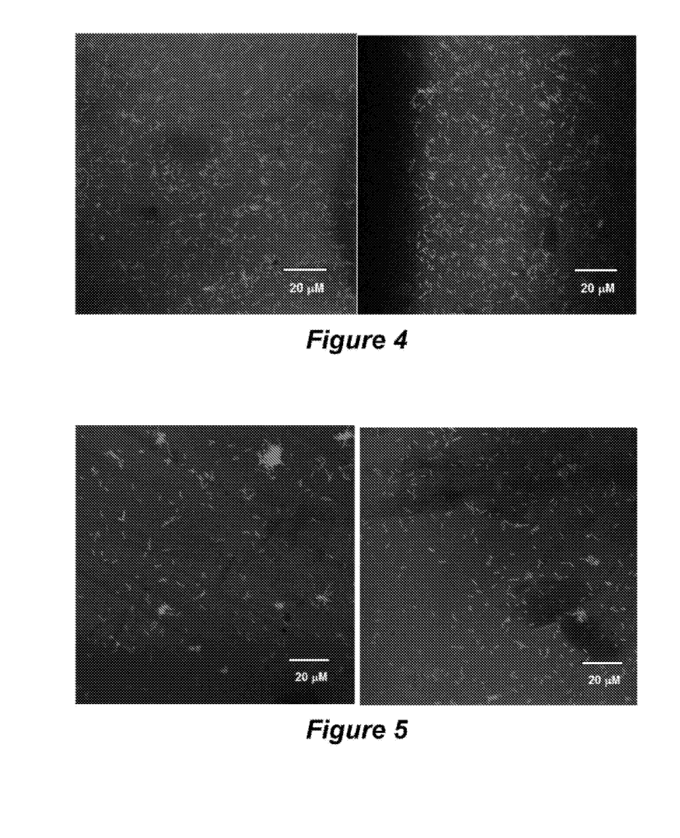

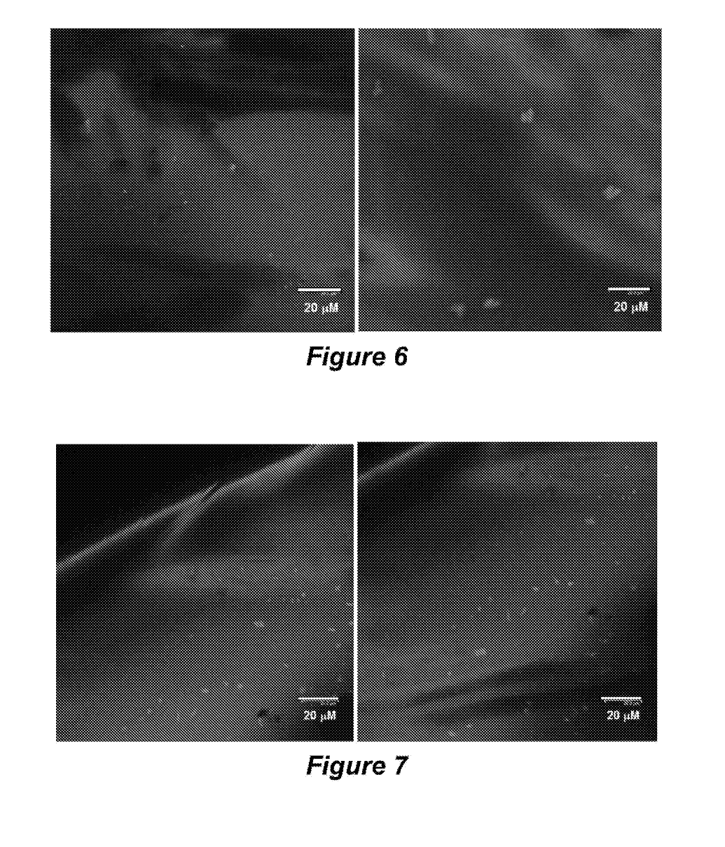

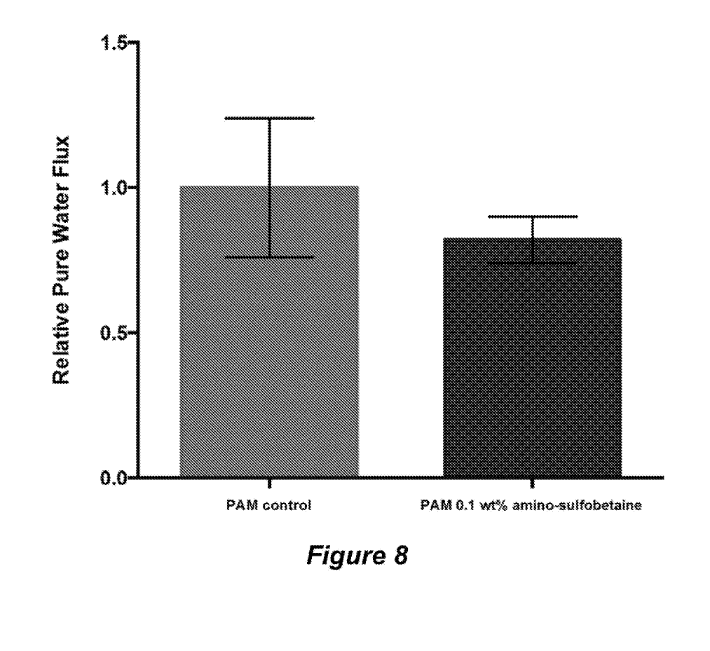

The data are shown in FIGS. 4 to 7. It can clearly be seen that after 0.1 wt % amino-sulfobetaine addition in polyamide RO membranes via an interfacial addition process results in much lower bacterial fouling. It is this concentration which will be used for the stirred cell measurements.

### Example 5

### Permeation Studies of Polyamide Amino-Sulfobetaine Thin Film Composite (ITO Membranes

All permeation tests of polyamide membranes (PAM) and 0.1 wt % amino-sulfobetaine PAMs were conducted using a dead-end stirred cell (HP4750, Sterlitech Corp. Washington, USA) with Milli-Q water (18 MΩ.cm) and standard saline solution (NaCl, 2000 ppm) at 25° C. The effective membrane filtration area was 14.6 cm⁻ and the working volume was approximately 200 mL. All permeation experiments were performed at 2400 kPa (348 psi) of transmembrane pressure that was controlled by a high-pressure nitrogen vessel with a gas pressure regulator. The permeate volume was collected in a glass beaker and weighed to determine flux. The electronic balance was connected to a computer and weight measurements were collected every 5 min using a Lab VIEW (National Instruments, USA) software program. All membrane types were tested in triplicate.

The pure water flux (J_{w}) was calculated according to Equation 1.

$${J}_{W} = \frac{V}{A Δ t} \qquad Equation 1$$

where, V is the volume of permeated water (L), A is the effective membrane area (m²) and Δt is the change in time (h).

For salt rejection analysis, conductivities of the feed solution and permeate were measured using a conductivity meter (Extech Equipment, Australia), and converted to concentration units (mg/L) using a calibration curve. Salt concentration measurements (mg/L) were used to calculate salt rejection using Equation 2.

$$SR ( \% ) = 1 - ( \frac{{C}_{perm}}{{C}_{feed}} ) \times 100 \% \qquad Equation 2$$

where, Cₚₑᵣₘ is the permeate concentration and C_{feed} the feed concentration,

To eliminate the effect of the differences between each PAM, relative water flu (η) was used to characterise the variation of water flux due to modification with 0.1 wt % amino-sulfobetaine. The relative water flux (η) was calculated using Equation 3.

$$η = \frac{{J}_{w}}{{J}_{0}} \qquad Equation 3$$

where, J_{w} and J₀ (Lm⁻²h⁻²) are the pure water flux of membranes with and without 0.1wt % amino-sulfobetaine modification, respectively.

Similarly, relative salt rejection (τ) was used to characterise the variation of salt rejection due to modification with 0.1 wt % amino-sulfobetaine. The relative salt rejection (τ) was calculated by using equation 4.

$$τ = \frac{{SR}_{mod}}{{SR}_{0}} \qquad Equation 4$$

where, SR_{mod} and SR₀ are the calculated salt rejection of membranes with and without 0.1 wt % amino-sulfobetaine modification, respectively,

The permeation tests carried out at 2400 kPa (348 psi) revealed a reduction in pure water flux of approximately 20% for the 0.1 wt % amino-sulfobetaine modified polyamide membranes relative to the control polyamide membranes, however, given the overlap in the error bars the difference in flux is not considered statistically significant (FIG. 8). In addition, the relative salt rejection (τ) properties of the 0.1 wt % amino-sulfobetaine modified membranes were 20% less than for the control polyamide membranes.

### Example 6

### Further Anti-Bifouling Studies (Bacterial Resistance Test) of Polyamide Amino-Sulfobetaine Thin Film Composite (TFC) Membranes

Fouling testing was carried out using Pseudoalteromonas atlantica cultured in Difco Marine Broth in cross flow units operated under standard conditions.

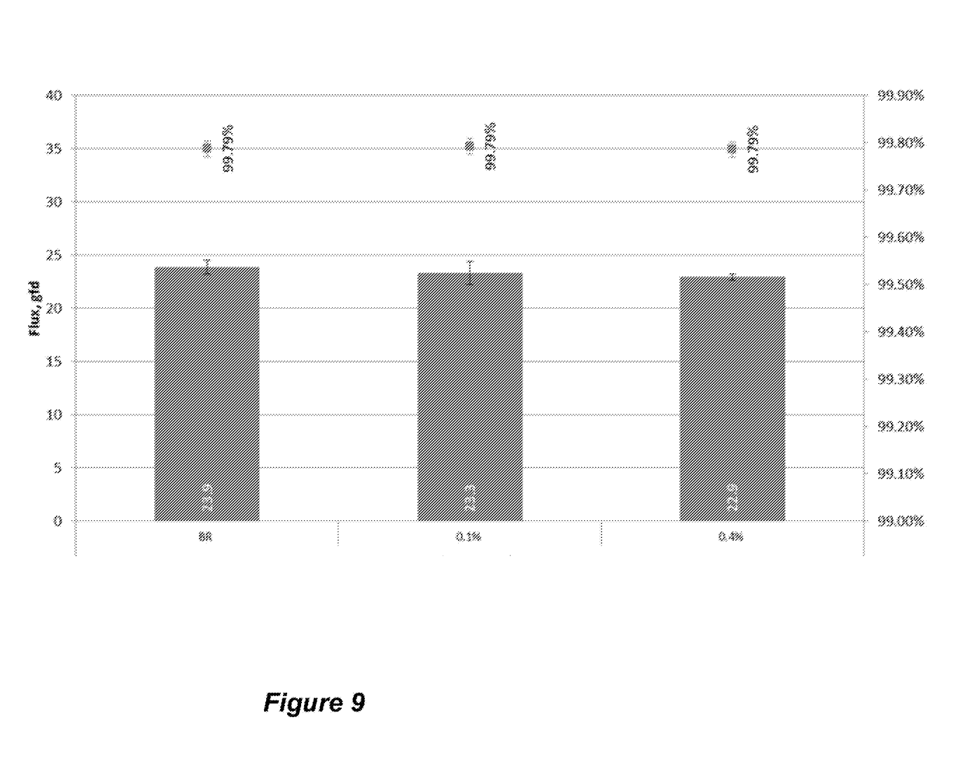

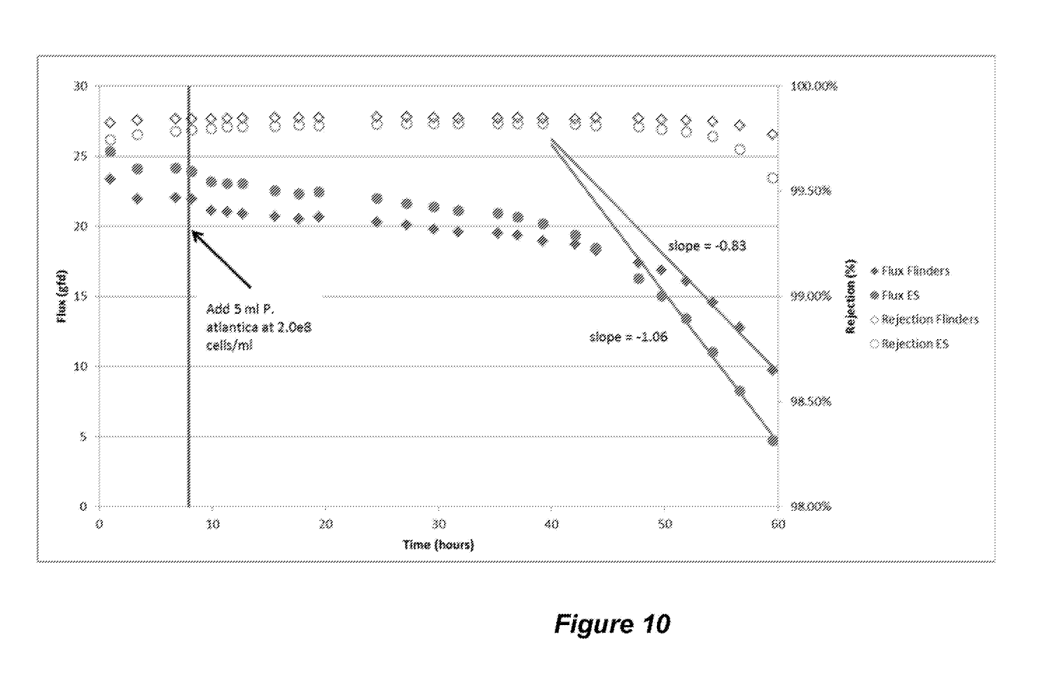

The data are shown in FIGS. 9 and 10. The data shows a benefit using the coated membranes of the present invention relative to a commercially available membrane. Specifically, there was a significant delay to fouling flux decline for the coated membranes of the present invention and the flux loss was not as pronounced.

When the slope of the flux loss is normalized with respect to the stabilized flux there is a benefit with the membranes of the present invention (−0.035/hr) relative to a standard commercially available membrane (−0.042/hr).

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1-64. (canceled)

65. A cross-linked copolymer formed by co-polymerisation of an aromatic diamine monomer, an amino zwitterionic monomer and a cross-linking monomer comprising a plurality of amine-reactive functional groups.

66. The cross-linked copolymer according to claim 65, wherein the aromatic diamine monomer is m-phenylenediamine.

67. The cross-linked copolymer according to claim 65, wherein the amino zwitterionic monomer is selected from the group consisting of sulfobetaine, phosphobetaine, and carboxybetaine monomers.

68. The cross-linked copolymer according to claim 65, wherein the amino zwitterionic monomer is selected from the group consisting of mono-amino and di-amino monomers.

69. The cross-linked copolymer according to claim 68, wherein the amino zwitterionic monomer has a structure according to formula (I): 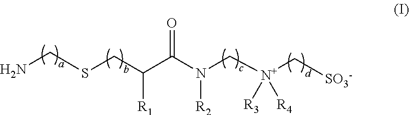
wherein: a, b, c, and d are integers each of which is independently selected from the group consisting of 1, 2, 3, 4, and 5; R₁ and R₂ are each independently selected from the group consisting of H and optionally substituted C₁-C₆ alkyl; and R₃ and R₄ are each independently selected from the group consisting of optionally substituted C₁-C₆ alkyl, optionally substituted C₃-C₆ cycloalkyl, and optionally substituted aryl.

70. The cross-linked copolymer according to claim 69, wherein a is 2.

71. The cross-linked copolymer according to claim 69, wherein b is 1.

72. The cross-linked copolymer according to claim 69, wherein c is 3.

73. The cross-linked copolymer according to claim 69, wherein d is 3.

74. The cross-linked copolymer according to claim 69, wherein R₁ is methyl.

75. The cross-linked copolymer according to claim 69, wherein R₂ is H.

76. The cross-linked copolymer according to claim 69, wherein R₃ and R₄ are both methyl.

77. The cross-linked copolymer according to claim 65, wherein the cross-linking monomer is an aromatic monomer.

78. The cross-linked copolymer according to claim 77, wherein the cross-linking monomer has a structure according to formula (III): 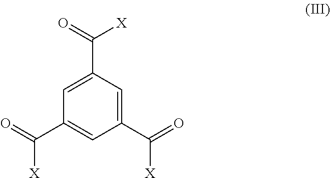
wherein X is a leaving group.

79. The cross-linked copolymer according to claim 78, wherein X is Cl.

80. The cross-linked copolymer according to claim 65, wherein the aromatic diamine monomer comprises m-phenylenediamine, the cross-linking monomer comprises trimesoyl chloride and the amino zwitterionic monomer comprises the compound of formula (II):

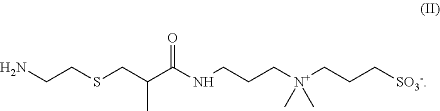

81. A composite filtration membrane comprising a porous support membrane and an antibiofouling polyamide layer on the porous support membrane, said antibiofouling polyamide layer comprising the cross-linked copolymer according to claim 1.

82. A method for producing a composite filtration membrane, the method comprising: depositing, on a porous support membrane, a mixture comprising an aromatic diamine monomer, an amino zwitterionic monomer and a cross-linking monomer comprising a plurality of amine-reactive functional groups; and allowing the aromatic diamine monomer and amino zwitterionic monomer to react with the cross-linking monomer to form an antibiofouling cross-linked polymer layer on the porous support membrane.

83. The method according to claim 82, wherein the step of depositing the mixture comprising the aromatic diamine monomer, the amino zwitterionic monomer and the cross-linking monomer on the porous support membrane comprises depositing, on the porous support membrane, an aqueous mixture comprising the aromatic diamine monomer and the amino zwitterionic monomer to form an initial film layer; and then contacting the initial film layer with a mixture comprising the cross-linking monomer and a solvent.
